(19) United States
(12) Patent Application Publication
(10) Pub. No.: US 2008/0182738 A1
(43) Pub. Date: Jul. 31, 2008

(54) ROBOTIC END-OF-ARM TOOL QUICK-CHANGE DEVICE

(76) Inventors: Terry Grunke, Verona, WI (US); Rick Mobley, Oregon, WI (US)

Correspondence Address: Intellectual Property Department;DEWITT ROSS & STEVENS S.C., Suite 600, 2 East Mifflin Street, Madison, WI, 53703-2865, US

(21) Appl. No.: 12/023,297

(22) Filed: Jan. 31, 2008

Related U.S. Application Data
(60) Provisional application No. 60/887,466, filed on Jan. 31, 2007.

(51) Int. Cl. B23Q 3/155

(52) U.S. Cl. 483/69

(57) ABSTRACT

A two-piece tool changing device is described. The changing device includes a base and a plate that nests with the base. The base includes a body along with guide brackets and a manifold attached to, or defined within, the base at a point along the peripheral edge of the base. The plate includes shoulders that reversible engage with the guide brackets. A standing section extends from the manifold toward the guide brackets, and defines a channel between the standing section and the body. A spring-biased plunger is optionally disposed within an aperture in the standing section, and the spring plunger is movable between a first position extending into the channel and a second position withdrawn from the channel. At least one conduit is optionally defined in the manifold and a corresponding conduit is defined in the plate, such that the conduit in the manifold and the conduit in the plate are in registration when the plate is nested in the base.

### CROSS-REFERENCE TO RELATED APPLICATIONS

Priority is hereby claimed to provisional application Ser. No. 60/887,466, filed Jan. 31, 2007, which is incorporated herein.

### FIELD OF THE INVENTION

The invention is directed to a robotic tool changer that enables robotic tooling, especially tools mounted at the end of a robotic arm, to be changed quickly and without using additional hand tools to complete the change.

### BACKGROUND

Robotic tool changers are generally known. Several different mechanisms have been described. For example, actively-powered tool changers use pneumatic or electrical means to establish the connection between the robot arm and the desired tool. See, for example, U.S. Pat. No. 4,676,142. Mechanical or passive systems use the robot's own wrist motion to establish a mechanical link between the robot and the desired tool. See, for example, U.S. Pat. No. 4,512,709. A host of other mechanisms have been described. For example, U.S. Pat. No. 5,044,063 describes a passive robotic tool change mechanism designed to operate in zero-gravity environments.

As noted in U.S. Pat. No. 4,660,274, in many robotic applications it is very desirable for the tool-changing apparatus to be devoid of switches, motors, or other “active” types of components. Not only are these “active” components expensive, they require rigorous routine maintenance, and are prone to failure absent diligent routine maintenance.

A host of tool changers are automatic, meaning that the robot itself can make and break the wrist linkage between tools without human intervention. See, for example, any of U.S. Pat. Nos. 4,512,709; 4,604,787; 4,637,121; and 5,993,365. There are, however, a great many robotically-implemented processes that do not require the complexity of either an “active” type of linkage or an automatic mechanism for changing tools. In many industrial processes that use robots, a relatively small number of tools are attached to the robot. On one hand, the number of tool changes required in these situations is likewise relatively small. Thus the high cost of an automatic tool-changing system cannot be justified. On the other hand, the tool changes (while small in number) still must take place for the robot to accomplish its assigned tasks. Without an automatic tool changer, each tool change entails robot down-time and human manual input to detach the current tool and to attach another, different tool. Therefore, even in robotic processes that require only a small number of tool changes, and where those tool changes are accomplished manually, those tool changes need to take place as quickly as possible, yet with an absolute maximum level of safety and security. Industrial robots are extremely powerful machines. A tool that is improperly attached to the robot due to haste or inattention on the part of the human operator not only can destroy the work piece which the robot is manipulating, but seriously injure or kill the operator and others working near the robot.

Thus there remains a long-felt need for a secure, passive, manually-operated, quick-change device for changing tools at the end of a robotic arm.

### SUMMARY OF THE INVENTION

The invention is a tool-changing device for robotic arms. One version of the device comprises, in combination, a base and a nesting plate. The base comprises a body, guide brackets attached to or defined within the body, a manifold attached to, or defined within the body at a point along the peripheral edge of the body; and a standing section extending from the manifold toward the guide brackets, such that a channel is defined between the standing section and the body. The plate has a peripheral edge and is dimensioned and configured to nest in face-to-face orientation with the body of the base. The plate comprises at least two shoulders that are dimensioned, configured, and positioned to engage the guide brackets of the base. When the shoulders are engaged to the guide brackets, at least a portion of the plate is disposed within the channel defined between the standing section and the body. When the plate is nested within the base, a reversible linkage is established between the base and the plate.

In other versions of the invention, an aperture is defined in the standing section and passing through the standing section. A corresponding aperture is defined in the plate. Thus, the aperture in the standing section and the aperture in the plate are in registration when the plate is nested in the base. A spring-biased plunger is optionally disposed within the aperture in the standing section. The spring plunger is movable between a first position extending into the channel defined between the standing section and the body, and a second position withdrawn from the channel.

In the preferred version of the invention, at least one conduit is defined in the manifold. The conduit passes through the manifold. There is also a corresponding conduit defined in the plate. The conduit in the manifold and the conduit in the plate are in registration when the plate is nested in the base. In the preferred version, the conduit in the plate has a first open end and a second open end, and the first and second open ends are disposed in the peripheral edge of the plate. The tool changer may include eight (8) or more conduits defined in the manifold and passing therethrough, and a corresponding eight (8) or more conduits defined in the plate. As before, the conduits in the manifold and the conduits in the plate are in registration when the plate is nested in the base.

The invention has several advantages, the foremost of which is that it provide a robust and secure linkage between a robotic arm and a tool, while at the same time the linkage is easily broken and reestablished by human intervention. The invention allows robotic arm-end tools to be changed quickly and without the need for additional hand tools.

### BRIEF DESCRIPTION OF THE DRAWINGS

FIG. 1A is a left perspective view of the preferred version of the invention showing the plate 12 engaged with the base 14.

FIG. 1B is a right perspective view of the preferred version of the invention showing the plate 12 engaged with the base 14.

FIG. 2A is a left perspective view as shown in FIG. 1A, with the plate 12 disengaged from the base 14.

FIG. 2B is a right perspective view as shown in FIG. 1B, with the plate 12 disengaged from the base 14.

FIG. 2C is a left, bottom perspective view of the invention, with the plate 12 disengaged from the base 14, and illustrating the apertures passing through the air/vacuum manifold 22.

FIG. 3A is a right elevation view of the preferred version of the invention with the plate 12 engaged with the base 14.

FIG. 3B is a left elevation view of the preferred version of the invention with the plate 12 engaged with the base 14.

FIG. 4A is a right elevation view as shown in FIG. 3A, with the plate 12 disengaged from the base 14.

FIG. 4B is a left elevation view as shown in FIG. 3B, with the plate 12 disengaged from the base 14.

FIG. 5 is a front elevation view of the preferred version of the invention with the plate 12 engaged with the base 14.

FIG. 6 is a top plan view of the preferred version of the invention with the plate 12 engaged with the base 14.

FIG. 7 is a front perspective view of the assembled base 14

FIG. 8 is an exploded front perspective view of the base 14, illustrating how the guide brackets 18 and air/vacuum manifold 22 attach to the body 16.

FIG. 9 is a left perspective view of the plate 12 and interlocking bushing 28, and showing the apertures 50-54.

FIG. 10 is a perspective view of the plate 12, illustrating the shoulders 30 that interlock with the guide brackets 18 of the base 14.

FIG. 11 is a front elevation view of another version of the invention with the plate 12 engaged with an electrical adaptor 60.

FIG. 12 is a front elevation view of yet another version of the invention with the base 14 engaged with an electrical adaptor 60′.

### DETAILED DESCRIPTION

The same reference numerals are used throughout all of the drawings to identify the same elements in each of the drawings.

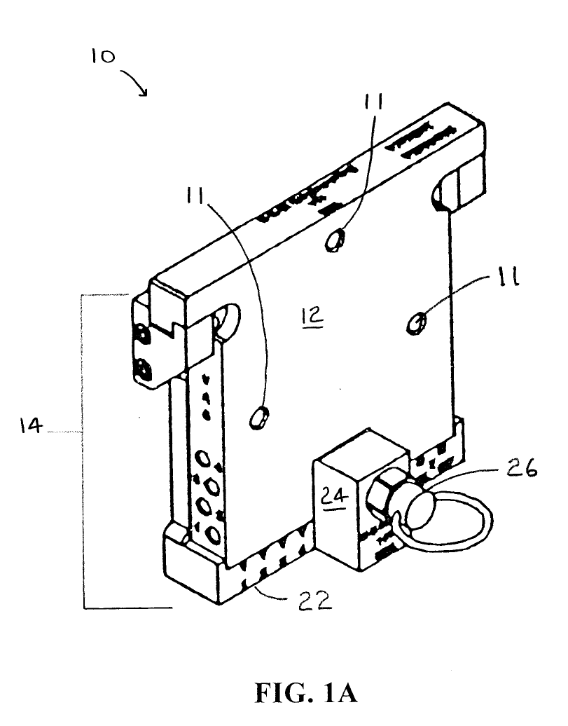

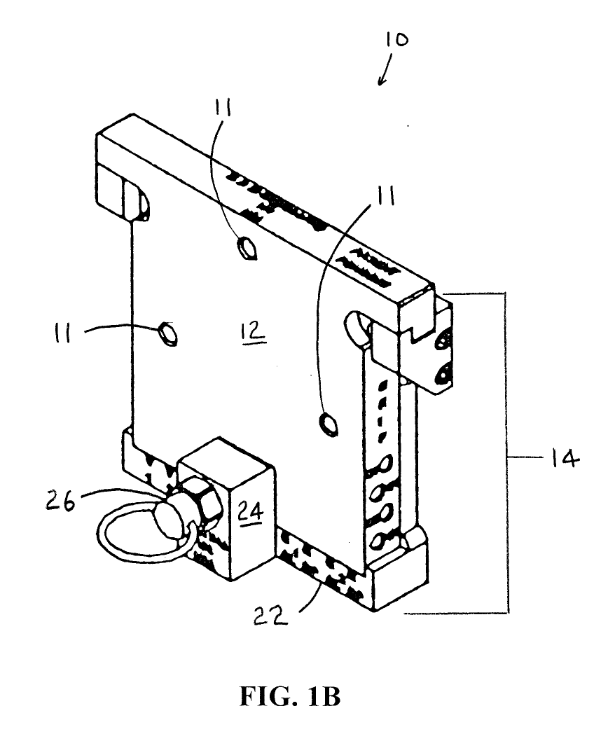

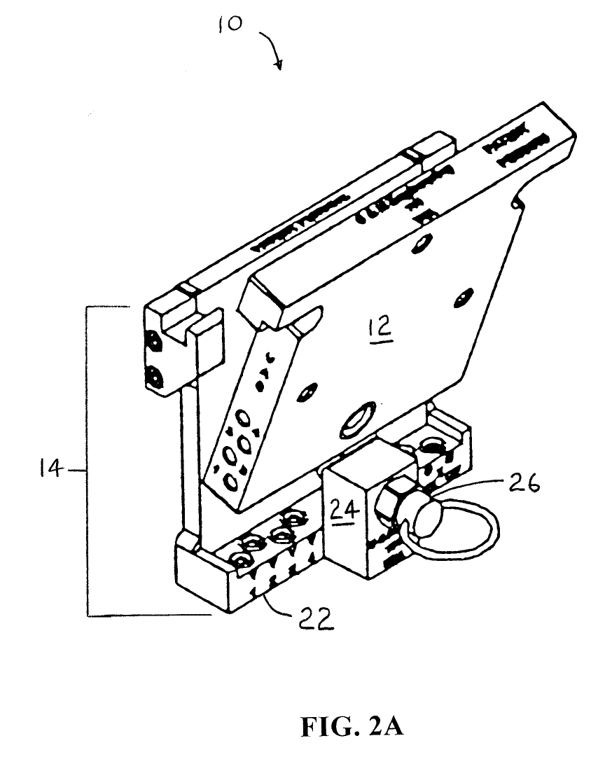

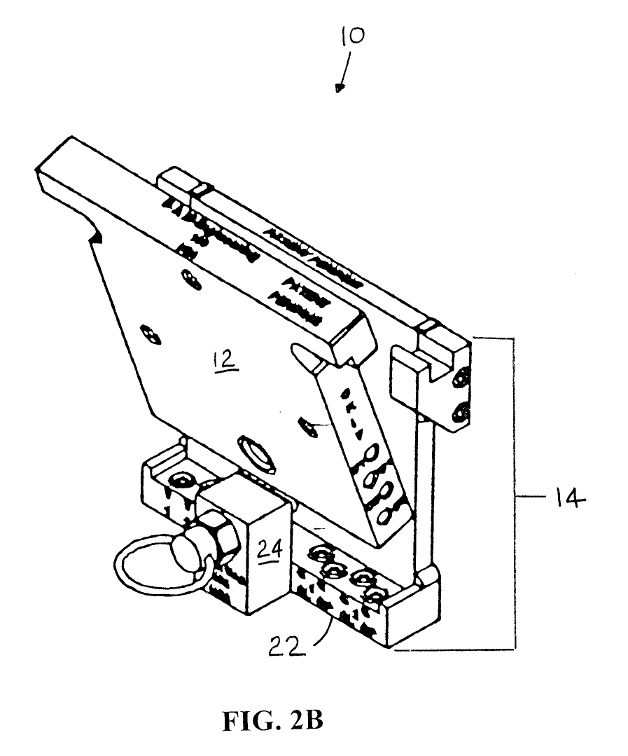

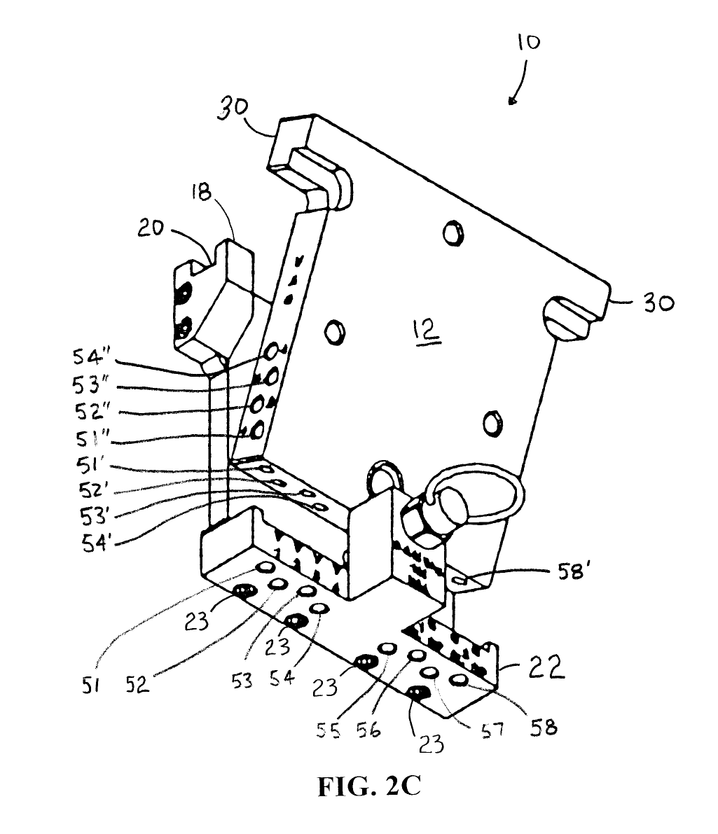

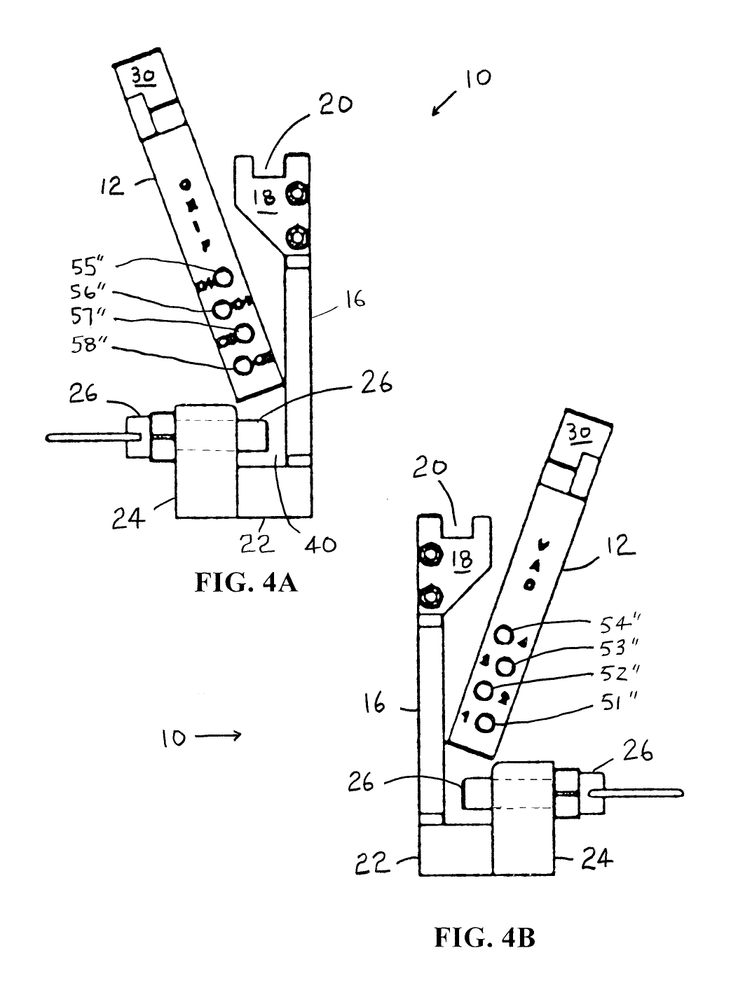

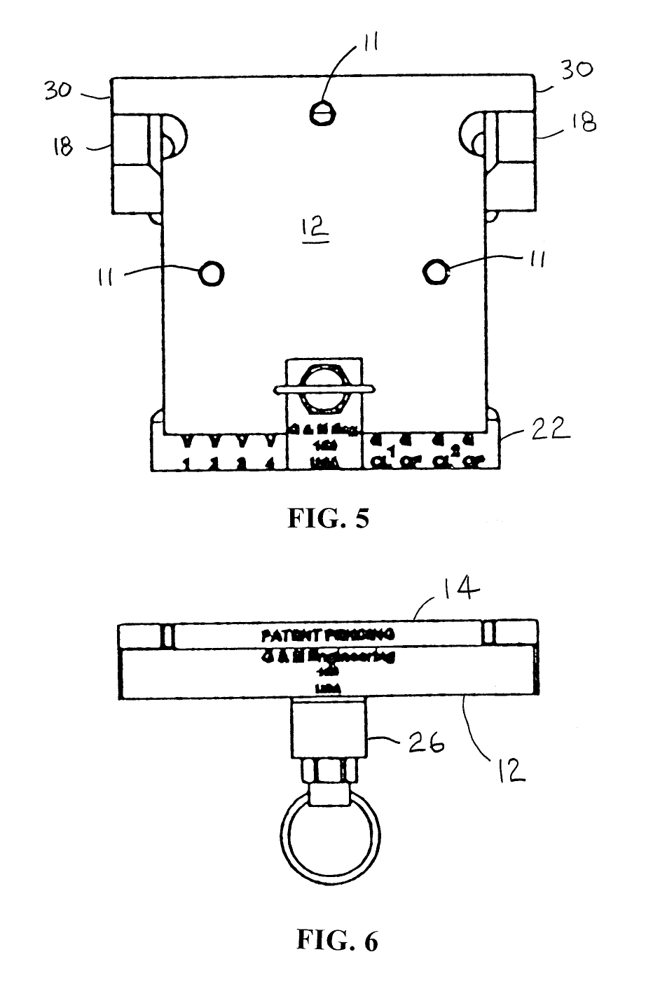

Referring now to FIGS. 1A, 1B, 2A, 2B, 2C, 3A, 3B, 4A, 4B, 5 and 6, these figures depict a quick-change device 10 according to the present invention. The device 10 includes two major parts: a plate 12 and a complementary base 14. The plate 12 is dimensioned and configured to securely engage the base 14. Vice-versa, the base 14 is dimensioned and configured to securely engage the plate 12. FIGS. 1A, 1B, 3A, 3B, 5 and 6 depict the plate 12 engaged with the base 14. FIGS. 2A, 2B, 2C, 4A, and 4B are exploded views depicting the plate 12 separated from the base 14.

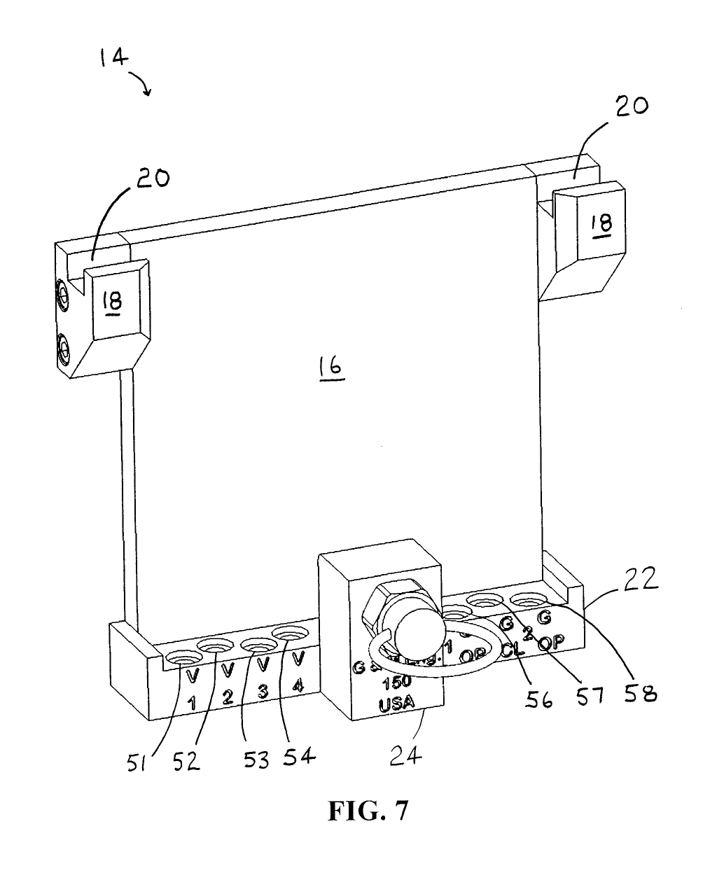

Referring specifically to FIG. 7, the base 14 is comprised of several parts that are either machined from a single billet of material (i.e., the base can be monolithic) or which are formed from distinct parts that are then assembled to yield the base 14. As shown in FIG. 7, the base 14 comprises a body 16 having attached to it or defined within it a pair of opposed guide brackets 18. Preferably each guide bracket defines a channel 20, and the two channels are co-linear, as shown in FIG. 7. The body 16 also has attached to it, or defined within it, an air/vacuum manifold 22 having a plurality of apertures 51-58 passing through the manifold. (See FIG. 2C for aperture 55, which is hidden from view in FIG. 7.) A standing section 24, extending from the manifold 22, is provided such that a channel 40 (see FIG. 4A) is defined between the standing portion 24 and the body 16.

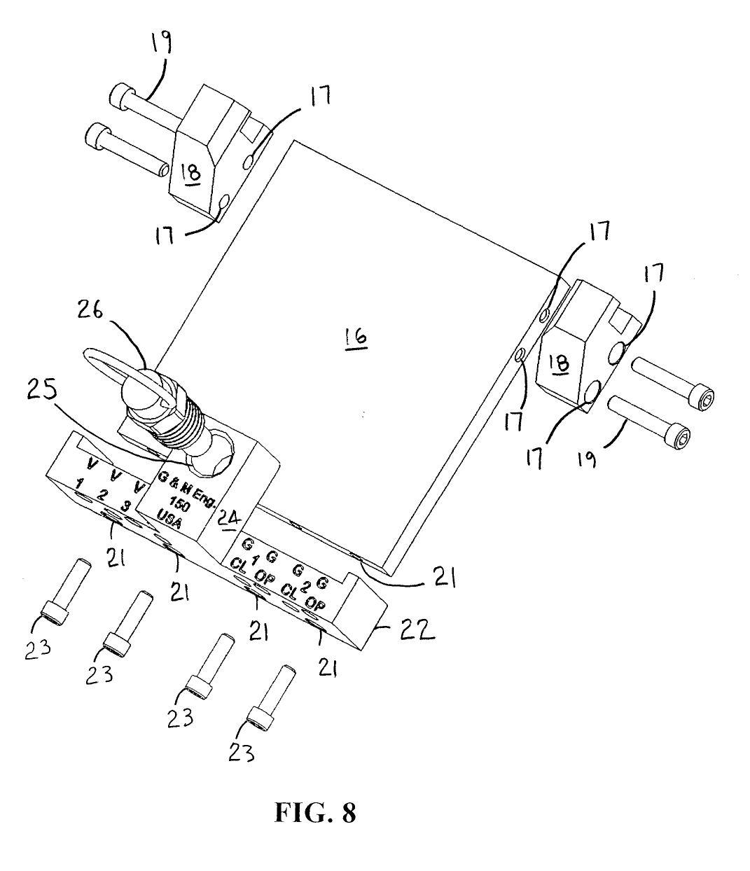

FIG. 8 depicts an exploded version of the base 14 as shown in FIG. 7. As noted in the prior paragraph, the various sub-elements of the base 14 can either be machined from a single billet, or, as shown in FIG. 8, fabricated separately and then brought together. As shown in FIG. 8, the various parts (described in full momentarily) are attached to a body 16 by fasteners 19 and 23. (The fasteners can be of any design, without limitation, including screws, pins, rivets, etc.) Preferably, the various elements of the base are attached to the body 14, rather than body and associated parts being milled from a single block of material. The plate 12 can then be engaged with the base 14, and the fasteners 23 and 19 are adjusted to ensure a snug fit between the plate and the base. It is preferred that once a suitably snug fit of the plate into the base is attained, the various elements (guide brackets 18 and manifold 22) are then permanently welded to the body 16, to insure the rigidity and robustness of the linkage between the base and the body.

Shown in FIG. 8 are the body 16 and two guide brackets 18. The guide brackets are affixed to the body via fasteners 19 that pass through corresponding apertures 17 in each guide bracket 18 and into the body 16. Similarly, the air/vacuum manifold 22 is affixed to the body via fasteners 23 that pass through corresponding apertures 21 in the manifold 22 and the body 16. The standing section 24 includes an aperture 25 passing therethrough. The aperture 25 is dimensioned and configured to accept a spring plunger 26. The spring plunger is biased to extend into and through aperture 25. That is, the spring plunger is biased to extend all the way through the standing section 24. This is best shown in FIGS. 4A and 4B. The spring plunger can be withdrawn from aperture 25 by pulling on the ring, thus allowing the plate to be inserted into channel 40 as shown in FIGS. 4A and 4B. The aperture 25 and spring plunger 26 may be threaded, or the spring plunger may be friction fit, glued, welded, or otherwise immobilized within the aperture 25.

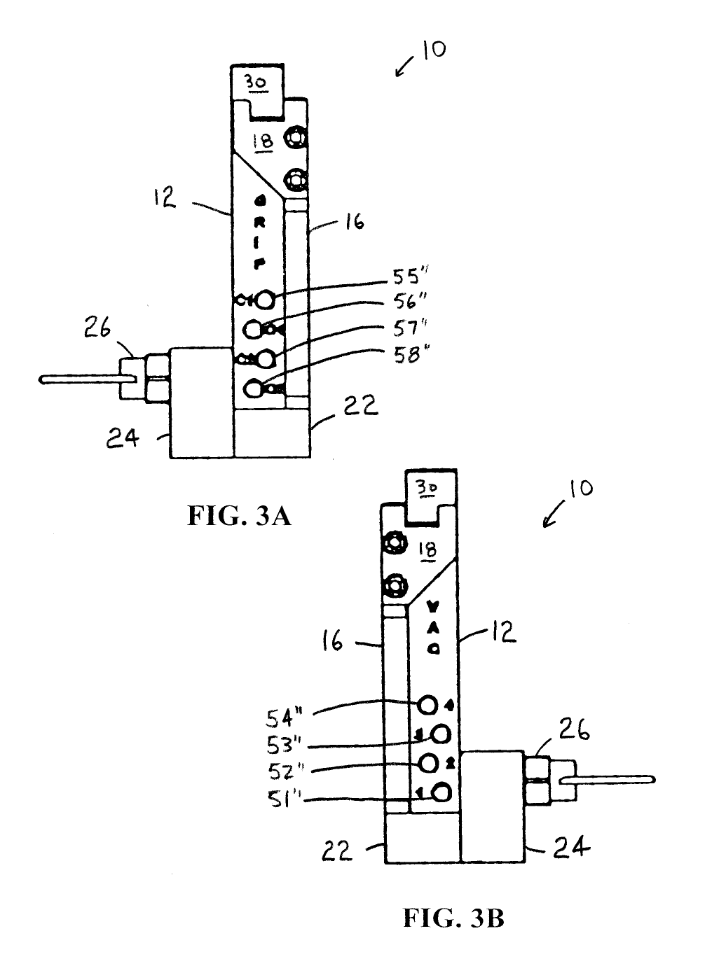

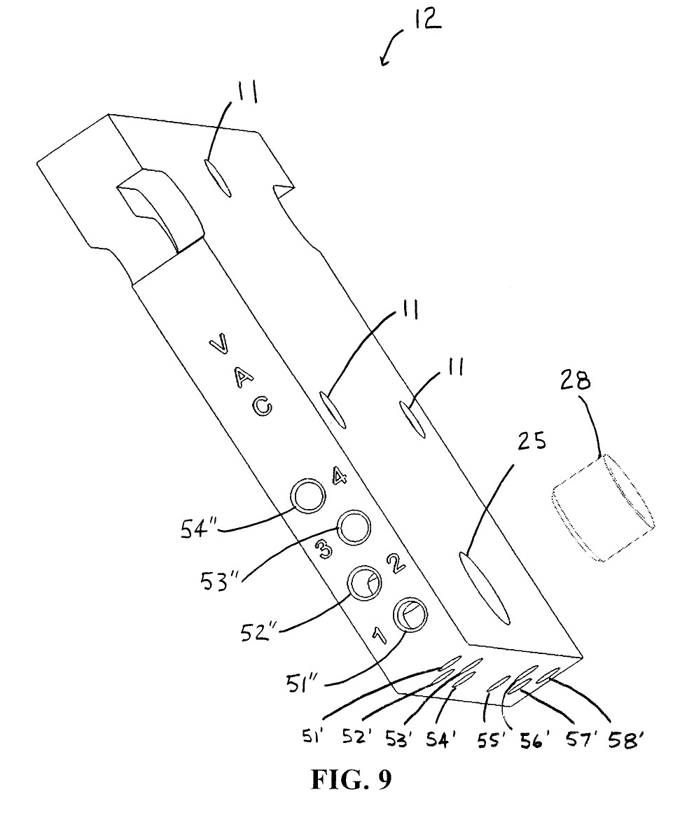

Referring now to FIGS. 2C and 7, passing through the air/vacuum manifold 22 are a series of channels, 51-58. The upper opening of these channels (that is, the openings depicted in FIG. 7) are in registration with a corresponding series of channels defined within the plate 12. This is best seen in FIG. 2C. See also FIG. 9 for a view of the corresponding channels in the plate 12. For clarity, the channels in the plate are defined by corresponding numbers, and using prime symbols to designate each end of the channel. Thus, 51′ and 51″ define each end of a channel passing through the plate 12. The same applies for 52′ and 52“and so on, up to 58′ and 58″. Thus, when the plate 12 is engaged with the base 14, channel 51 in the manifold is in registration with channel opening 51′ in the plate 12; channel 52 in the manifold is in registration with channel opening 52′ in the plate 12; and so on, up to channel 58 in the manifold, which is in registration with channel opening 58′ in the plate 12. Thus, when the plate 12 is engaged with the base 14, there are 8 conduits passing through the manifold 22 and the plate 12. This conduits can be designated by their channel openings: 51 and 51″, 52 and 52″, 53 and 53″, 54 and 54″, and so on, as shown in FIG. 2C. The channel openings 51″ through 58″ are best seen in FIGS. 3A and 3B. These channels can be used for pneumatic, hydraulic or electrical control elements to pass through the device of the present invention to the tool affixed to the plate 12 of the device.

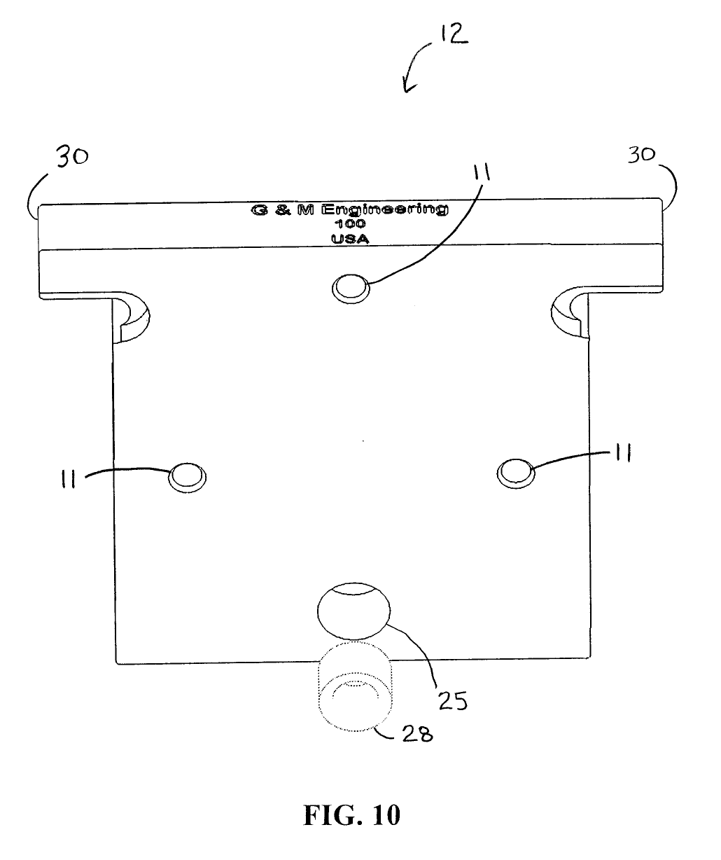

Referring now to FIGS. 9 and 10, the plate 12 has an aperture 25′ passing therethrough, and a bushing 28 that is fit within the aperture 25′. The bushing is for wear resistance in the event the plate 12 is made of aluminum and the spring plunger 26 is made of a stronger metal, such as steel. In that instance, the plunger would cause wear on aperture 25′. Thus, the bushing 28 is preferably made of any suitably stiff, wear-resistant material, such as steel or other alloys. With the bushing 28 inside the aperture 25′, the aperture 25′ of the plate lines up in registration with aperture 25 and spring plunger 26 of the base 14 (see FIGS. 8, 4A, and 4B). Additionally, the plate 12 includes shoulders 30 that are dimensioned and configured to engage with the guide brackets 18 of the base 14. Thus, to engage the plate 12 with the base 14, the spring plunger 26 is manually withdrawn through aperture 25, thus providing clearance through channel 40. The plate 12 is inserted into channel 40, in face-to-face orientation with body 16. (See FIGS. 4A and 4B). At the moment the plate 12 is inserted fully into channel 40, and pushed into face-to-face contact with the body 16, two things occur: (1) the shoulders 30 of plate 12 firmly engage within the channel 20 defined by guide brackets 18; and (2) the biased action of the spring plunger 26 forces the spring plunger back through aperture 25 of the base and into aperture 25′ of the plate. Thus, the plate 12 is firmly engaged or nested with the base 24, as shown in FIGS. 1A, 1B, 3A, and 3B.

In operation, a plate 12 is affixed to the tool to be used (not shown) by any means now known in the art or developed in the future. Preferably this is done via fasteners (not shown) that pass through apertures 11 in the plate. Preferably, the plate is attached to the tool in a semi-permanent manner. In short, to make tool changes faster, each tool should have attached to it a plate 12. The base 14 is affixed to a robot arm by any means now know to the art or developed in the future. To change tools, the user simply pulls on spring plunger 26 with one hand, and removes the tool (with its affixed plate 12) from the base 14. A new tool (with its own affixed plate 12) is then engaged with the base 14 via the tool's affixed plate.

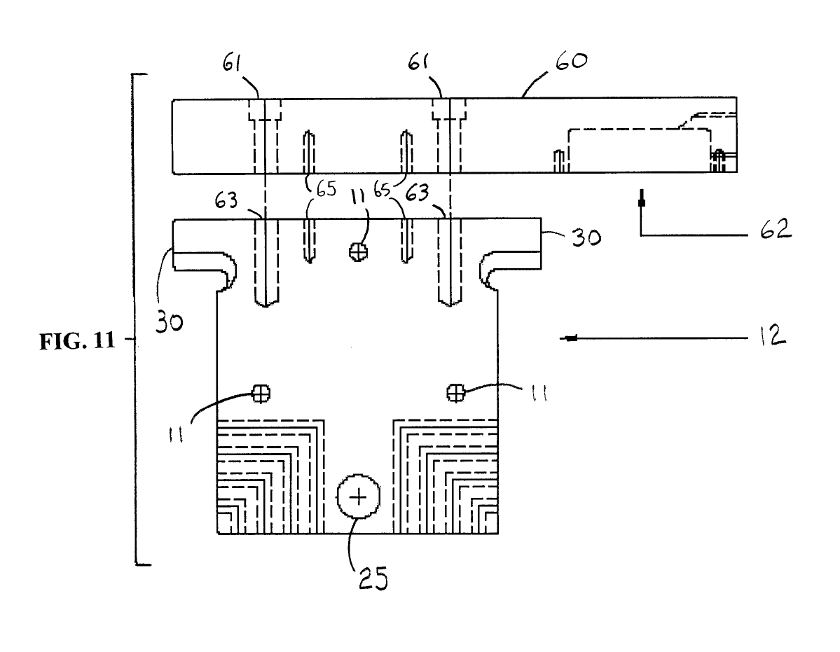

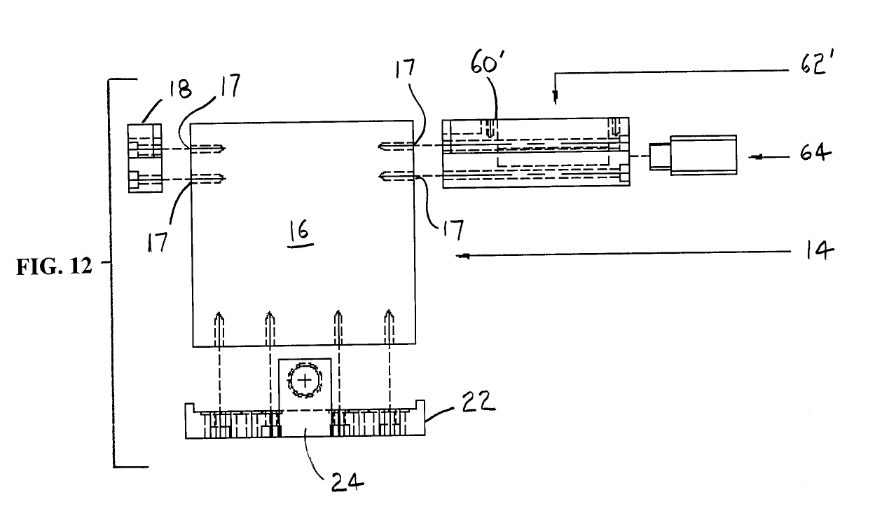

FIGS. 11 and 12 show alternative versions of the invention wherein an electrical adapter, 62 in FIG. 11 and 62′ in FIG. 12, is attached to the plate 12 or to the base 14 (or both). Referring now to FIG. 11, the adaptor 60 is shown having apertures 61 passing therethrough. The apertures are in registration with corresponding apertures 63 in the plate 12. Dowel pin holes 65 are provided to ensure that the adapter 62 is fixed to the plate 12 in proper registration. Dowels (not shown in FIG. 11) are inserted into the pin holes 65 to align the adapter 62 with the plate. The adaptor is attached to the plate using any suitable type of fastener, as noted earlier. The adaptor includes a pocket 62 defined therein to house any type of electrical connector or jack, such as a 25-pin DIN connector (not shown).

Similarly, as shown in FIG. 12, an electrical adaptor 60′ may also be attached to the body 16 of the base via apertures 17. As shown in FIG. 12, the adaptor includes a pocket 62′ defined therein to house any type of electrical connector or jack, such as a 25-pin DIN connector (not shown).

Providing the adaptors 60 and 60′ allows the device to provide instructions to or feedback from tools mounted to a robot via the quick-change device.

In terms of preferred dimensions and material, the following information relates solely to the preferred embodiment of the invention. Other materials and other dimensions are explicitly within the scope of the invention. The plate 12 is preferably machined from 6061 aluminum. The eight apertures 51′ to 58′ in plate 12 are preferably 0.159″ diameter. The eight corresponding apertures 51″ to 58″ are also preferably 0.159″ diameter. The depths of these apertures are such that aperture 51′ intersects with aperture 51″, creating a conduit, 52′ with 52″, and so on, up to the conduit between aperture 58′ and aperture 58″. Thus, in the preferred embodiment, plate 12 has eight conduits passing through it. The invention includes versions having at least one conduit, and more than eight conduits passing through the plate 12 and base 14. The apertures 11 are preferably drilled 0.201″ diameter and tapped 0.250″-20 through the plate thickness. Aperture 25′ is preferably drilled and reamed through the thickness of the plate and dimensioned and configured to accept a pressed in drill bushing (0.312 inch ID×0.500 inch OD×0.0375 thickness).

As shown in FIG. 8, the base preferably comprises four pieces of low-carbon, flat-ground steel machined into the elements that comprise the base 14. The body 16 preferably is machined from low-carbon, flat-ground steel stock. The apertures 21 for mounting the manifold 22 are preferably 0.106″ diameter. The apertures 17 for mounting the guide brackets 18 are also preferably 0.106″ diameter

The air/vacuum manifold 22 is machined from low-carbon steel. The apertures 21 (to attach the manifold to the body 16) are preferably 0.136″ diameter and counter bored 0.288″ diameter×0.150 deep to provide for clearance for fasteners 23 (preferably #6-32×0.0500 long socket head cap screws). Channels 51-58 are preferably 0.0159″ diameter and counter bored. The aperture 25 in the standing section 24 is preferably 0.422″ diameter. The spring plunger 26 is of a complementary diameter to engage within the aperture 25.

The guide brackets 18 are machined from low-carbon, flat-ground steel. Each guide bracket 18 preferably has a 0.325″ wide×0.210″ deep groove 20 machined in the top surface, as shown in the figures. The apertures 17 in each Guide Bracket are preferably 0.136″ diameter and counter bored 0.228″ diameter×0.150″ deep, which is the appropriate clearance for fasteners 19 (#6-32 UNC socket head cap screws) that fasten the guide brackets 18 to the body 16.

It is important to insure that the plate 12 can easily be nested and removed from the base 14. To ensure a optimized fit between the plate 12 and the base 14, the guide brackets 18 and manifold 22 are first attached to body 16 of the base using fasteners 19 and 23 as shown in FIG. 8. The plate 12 is then engaged with the base 14. With the plate nested within the base, all mating surfaces are then adjusted so that they are flush with each other. The fasteners 19 and 23 are then fully tightened and the fit again checked. The plate 12 should be able to be removed and nested within the base 14 without obstruction and by applying only a moderate amount of manual force. When seated within the base 14, however, the plate 12 is rendered immobile relative to the base 14.

Once a snug and easily releasable fit is obtained, the manifold 22 and the guide brackets 18 are preferably welded to the body 18, thus ensuring the dimensional stability of the base 14.

What is claimed is:

1. A tool-changing device comprising, in combination:
(a) a base comprising:
(i) a body having a peripheral edge and at least two guide brackets attached to, or defined within, the base at opposing points along the peripheral edge;
(ii) a manifold attached to, or defined within, the body at a point along the peripheral edge of the body; and
(iii) a standing section extending from the manifold toward the guide brackets, such that a channel is defined between the standing section and the body; and
(b) a plate having a peripheral edge and dimensioned and configured to nest in face-to-face orientation with the body of the base, wherein the plate comprises at least two shoulders that are dimensioned, configured, and positioned to engage the guide brackets of the base, and wherein when the shoulders are engaged to the guide brackets, at least a portion of the plate is disposed within the channel defined between the standing section and the body, and wherein when the plate is nested within the base, a reversible linkage is established between the base and the plate.

2. The tool changing device of claim 1, wherein an aperture is defined in the standing section and passing therethrough, and a corresponding aperture is defined in the plate, wherein the aperture in the standing section and the aperture in the plate are in registration when the plate is nested in the base.

3. The tool changing device of claim 2, further comprising a spring-biased plunger disposed within the aperture in the standing section, and wherein the spring plunger is movable between a first position extending into the channel defined between the standing section and the body, and a second position withdrawn from the channel.

4. The tool changing device of claim 1, further comprising at least one conduit defined in the manifold and passing therethrough, and a corresponding conduit defined in the plate, wherein the conduit in the manifold and the conduit in the plate are in registration when the plate is nested in the base.

5. The tool changing device of claim 4, wherein the conduit in the plate has a first open end and a second open end, and the first and second open ends are disposed in the peripheral edge of the plate.

6. The tool changing device of claim 1, further comprising eight (8) conduits defined in the manifold and passing therethrough, and a corresponding eight (8) conduits defined in the plate, wherein the conduits in the manifold and the conduits in the plate are in registration when the plate is nested in the base.

7. The tool changing device of claim 6, wherein the conduits in the plate each have a first open end and a second open end, and all of the first and second open ends are disposed in the peripheral edge of the plate.

8. The tool changing device of claim 6, wherein an aperture is defined in the standing section and passing therethrough, and a corresponding aperture is defined in the plate, wherein the aperture in the standing section and the aperture in the plate are in registration when the plate is nested in the base.

9. The tool changing device of claim 8, further comprising a spring-biased plunger disposed within the aperture in the standing section, and wherein the spring plunger is movable between a first position extending into the channel defined between the standing section and the body, and a second position withdrawn from the channel.

10. The tool changing device of claim 9, further comprising a bushing disposed in the aperture in the plate, and wherein the bushing is disposed between the standing section and the body when the plate is nested in the base.

11. The tool changing device of claim 1, further comprising an electrical adaptor attached to or defined within the base, or attached to or defined within the plate, or attached to or defined within both the base and the plate.

12. A tool-changing device comprising, in combination:
(a) a base comprising:
(i) a body having a peripheral edge and at least two guide brackets attached to, or defined within, the body at opposing points along the peripheral edge;
(ii) a manifold attached to, or defined within, the body at a point along the peripheral edge of the body;
(iii) a standing section extending from the manifold toward the guide brackets, such that a channel is defined between the standing section and the body, wherein an aperture is defined in the standing section and passing therethrough; and
(iv) a spring-biased plunger disposed within the aperture in the standing section, and wherein the spring plunger is movable between a first position extending into the channel defined between the standing section and the body, and a second position withdrawn from the channel; and
(b) a plate having a peripheral edge and dimensioned and configured to nest in face-to-face orientation with the body of the base, wherein the plate comprises at least two shoulders that are dimensioned, configured, and positioned to engage the guide brackets of the base, and wherein when the shoulders are engaged to the guide brackets, at least a portion of the plate is disposed within the channel defined between the standing section and the body, and further including an aperture defined in the plate and corresponding to the aperture in the standing portion, and wherein when the plate is nested within the base, the aperture in the standing section and the aperture in the plate are in registration and a reversible linkage is established between the base and the plate.

13. The tool changing device of claim 12, further comprising a bushing disposed in the aperture in the plate, and wherein the bushing is disposed between the standing section and the body when the plate is nested in the base.

14. The tool changing device of claim 12, further comprising at least one conduit defined in the manifold and passing therethrough, and a corresponding conduit defined in the plate, wherein the conduit in the manifold and the conduit in the plate are in registration when the plate is nested in the base.

15. The tool changing device of claim 13, wherein the conduit in the plate has a first open end and a second open end, and the first and second open ends are disposed in the peripheral edge of the plate.

16. The tool changing device of claim 12, further comprising eight (8) conduits defined in the manifold and passing therethrough, and a corresponding eight (8) conduits defined in the plate, wherein the conduits in the manifold and the conduits in the plate are in registration when the plate is nested in the base.

17. The tool changing device of claim 16, wherein the conduits in the plate each have a first open end and a second open end, and all of the first and second open ends are disposed in the peripheral edge of the plate.

18. The tool changing device of claim 13, further comprising an electrical adaptor attached to or defined within the base, or attached to or defined within the plate, or attached to or defined within both the base and the plate.

19. A tool-changing device comprising, in combination:
(a) a base comprising:
(i) a body having a peripheral edge and at least two guide brackets attached to, or defined within, the body at opposing points along the peripheral edge;
(ii) a manifold attached to, or defined within, the body at a point along the peripheral edge of the body;
(iii) a standing section extending from the manifold toward the guide brackets, such that a channel is defined between the standing section and the body, wherein an aperture is defined in the standing section and passing therethrough; and
(iv) a spring-biased plunger disposed within the aperture in the standing section, and wherein the spring plunger is movable between a first position extending into the channel defined between the standing section and the body, and a second position withdrawn from the channel; and
(b) a plate having a peripheral edge and dimensioned and configured to nest in face-to-face orientation with the body of the base, wherein the plate comprises at least two shoulders that are dimensioned, configured, and positioned to engage the guide brackets of the base, and wherein when the shoulders are engaged to the guide brackets, at least a portion of the plate is disposed within the channel defined between the standing section and the body, and further including an aperture defined in the plate and corresponding to the aperture in the standing portion, and a bushing disposed in the aperture in the plate, wherein when the plate is nested within the base, the aperture in the standing section and the aperture in the plate are in registration, the bushing is disposed between the standing section and the body, and a reversible linkage is established between the base and the plate.

20. The tool changing device of claim 19, further comprising at least one conduit defined in the manifold and passing therethrough, and a corresponding conduit defined in the plate, wherein the conduit in the manifold and the conduit in the plate are in registration when the plate is nested in the base.

21. The tool changing device of claim 20, wherein the conduit in the plate has a first open end and a second open end, and the first and second open ends are disposed in the peripheral edge of the plate.

22. The tool changing device of claim 19, further comprising eight (8) conduits defined in the manifold and passing therethrough, and a corresponding eight (8) conduits defined in the plate, wherein the conduits in the manifold and the conduits in the plate are in registration when the plate is nested in the base.

23. The tool changing device of claim 22, wherein the conduits in the plate each have a first open end and a second open end, and all of the first and second open ends are disposed in the peripheral edge of the plate.

24. The tool changing device of claim 19, further comprising an electrical adaptor attached to or defined within the base, or attached to or defined within the plate, or attached to or defined within both the base and the plate.
